(19) United States
(12) Patent Application Publication
(10) Pub. No.: US 2025/0047739 A1
(43) Pub. Date: Feb. 6, 2025

(54) Edge-Local Relay Selection and Assignment for Real-Time Communications

(71) Applicant: Cisco Technology, Inc., San Jose, CA (US)

(72) Inventors: Giovanna Carofiglio, Paris (FR); Jordan Augé, Saint-Cyr-l’Ecole (FR); Michele Papalini, Issy les Moulineaux (FR); Giulio Grassi, Paris (FR); Mauro Sardara, Issy Les Moulineaux (FR)

(21) Appl. No.: 18/364,162

(22) Filed: Aug. 2, 2023

(51) Int. Cl. H04L 67/101; H04L 43/0852; H04L 67/1008

(52) U.S. Cl. CPC H04L 67/101; H04L 43/0852; H04L 67/1008

(57) ABSTRACT

Systems and methods for associating a client computing device with an edge node. The method includes providing, by a cloud server, a resource to the client computing device. Filtering, by the cloud server, one or more edge nodes to identify a subset of edge nodes that meet a predetermined criteria and communicating the subset of edge nodes to the client computing device. The client probes the subset of edge nodes, and based on at least the probing results, the cloud server then selects one of the edge nodes from the subset to provide the resource to the client computing device.

### TECHNICAL FIELD

The present disclosure relates generally to a distributed cloud environment that includes a plurality of edge servers and, more particularly, to systems and methods for determining which edge server and/or node to use as a relay for providing resources and/or services to one or more client computing devices.

### BACKGROUND

Organizations in the recent past have increasingly utilized cloud environments to provide some or all their computing needs. The use of a cloud environment provided for massive rewards of visibility, elasticity, agility, flexibility, scale, security, and cost effectiveness. However, organizations have now begun to bring at least some computing back to a more local environment, such as the so-called edge computing environment. The edge computing environment comprising a plurality of edge nodes allows some computing to be performed closer to the end users or organization while still having some of the benefits of the cloud environment. The edge computing environment overcomes some of the deficiencies with cloud environments, such as bandwidth, latency, regulatory, and/or privacy concerns. However, selecting which edge server or node to offload cloud resources to is not a trivial matter, especially when the resources are related to real-time communications, such as live media distribution and/or video conferencing.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems and components depicted in the accompanying figures are not to scale and components within the figures may be depicted not to scale with each other.

FIG. 1 illustrates a system diagram of a network architecture for performing one or more embodiments.

FIG. 2 illustrates an example of a mapping of a system comprising multiple edge nodes and multiple client devices in accordance with at least one embodiment.

FIG. 3 illustrates a flow diagram of an example method for associating a client computing device with an edge node in accordance with at least one embodiment.

FIG. 4 illustrates a computer architecture diagram shown in an illustrative computer hardware architecture in accordance with at least one embodiment.

### DESCRIPTION OF EXAMPLE EMBODIMENTS

### Overview

One or more embodiments include a method for associating a client computing device with an edge node. One or more resources are provided to the client computing device from a cloud server. The cloud server maps one or more edge nodes based on predetermined criteria and filters the one or more edge nodes to identify a subset of the edge nodes. The subset of edge nodes is then communicated to the client computing device which probes each edge node in the subset of edge nodes. The results of these probes are returned to the cloud server which ranks the subset of edge nodes and selects the edge node with the highest rank. The client computing device is then signaled by the cloud server to begin receiving resources from the selected edge node.

In one or more embodiments, the predetermined criteria may include determining the number of other client computing devices using the resource on the one or more edge nodes. Using this determination, the one or more edge nodes that do not host other client computing devices using the resource may be filtered or eliminated. Similarly, those edge nodes that host a maximum number of client computing devices may also be eliminated.

In one or more embodiments, the resources may be a real-time application, such as, but not limited to, a video conferencing application. The one or more edge nodes, once selected, may function as a media bridge. The selection of the edge node may be based, at least in part, on maximizing the multicast effect while ensuring latency or delay in the communication is low. Latency may be determined by the client computing device when it probes the subset of edge nodes and the amount of latency along with other criteria may be used by the cloud server to rank the one or more edge nodes and select the edge node.

This disclosure additionally describes a system that includes a client computing device, one or more edge nodes, and a cloud server. The cloud server further includes one or more processors and one or more computer-readable non-transitory storage media coupled to the one or more processors that stores instructions operable when executed by the one or more processors to cause the system to perform a method. The method includes providing one or more resources to the client computing device from a cloud server. The cloud server maps one or more edge nodes based on predetermined criteria and filters the one or more edge nodes to identify a subset of the edge nodes. The subset of edge nodes is then communicated to the client computing device which probes each edge node in the subset of edge nodes. The results of these probes are returned to the cloud server that ranks the subset of edge nodes and selects the edge node with the highest rank. The client computing device is then signaled by the cloud server to begin receiving resources from the selected edge node.

This disclosure also describes at least one non-transitory computer-readable storage medium having stored instructions. When the instructions are executed by one or more processors, the instructions cause the processors to cause a cloud server to provide one or more resources to a client computing device. The cloud server maps one or more edge nodes based on predetermined criteria and filters the one or more edge nodes to identify a subset of the edge nodes. The subset of edge nodes is then communicated to the client computing device which probes each edge node in the subset of edge nodes. The results of these probes are returned to the cloud server that ranks the subset of edge nodes and selects the edge node with the highest rank. The client computing device is then signaled by the cloud server to begin receiving resources from the selected edge node.

Certain systems and methods described herein may allow for choosing an edge node from a plurality of edge nodes. The chosen edge node is then utilized, either directly from or as a relay, to provide a client computing device one or more resources previously provided directly from a cloud server. The systems and methods allow for a twostep process by which a cloud server that currently provides the resource may select or choose an edge node from the plurality of edge nodes associated with the cloud server. The cloud server first filters all the available edge nodes to eliminate those edge nodes that are unable to provide the resource in an efficient manner. Second, the cloud server then chooses a specific edge node based on criteria determined by probing the remaining edge nodes by the client computing device. By using this two-step method, cloud usage may be minimized while the client computing device continues to receive a resource at the same or improved quality.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

The present disclosure describes an approach that allows for efficiently utilizing available edge nodes to provide resources that have previously been provided from cloud environments in a distributed cloud environment. The distributed cloud allows an organization to utilize a hybrid combination of traditional cloud servers and edge nodes to provide resources and subsequently manage them as a unified system. However, determining which edge nodes are best at forwarding and/or providing a resource, especially for real-time applications such as video conferencing, remains a challenge. The present disclosure seeks to address this by introducing an optimal method for selecting from a plurality of edge nodes to provide the resource based on network and node utilization, as well as other criteria.

Realtime video conferencing, as well as similar real-time applications, generate significant traffic loads due to the large size of video data. At the same time, because of being real-time, interruptions or delays in the traffic are not well tolerated. Leveraging the use of edge nodes as relays in a video conferencing system may lead to large bandwidth and computational savings in the cloud. This also allows the cloud servers to be able to serve a larger number of users while guaranteeing a given quality of experience (QoE).

One of the benefits of leveraging edge nodes is that traffic from the media bridge (often deployed in the cloud) may be reduced, since edge nodes act as intermediate media switching nodes (relays) distributing media flows to connected participants. However, use of edge nodes as relays in real-time media communications is still in its infancy. Edge node assignments are often static. Because the assignments are static, when changes occur, such as new client devices being added to the system, changes in participation in a particular grouping, network changes, media bridge load changes, and a reduction of QoE may occur.

The present disclosure attempts to overcome these and other issues by utilizing a two-phase approach for performing an edge node assignment. First, the available edge nodes are filtered based on static mapping of the edge nodes based on such things as their location relative to a client computing device, the number of clients that a particular edge node is currently providing the same resource to, and network conditions between the edge node and cloud server. Additionally, filtering may be performed when the client computing devices are grouped in clusters based on their current uses. The filtering based on grouping, if possible, attempts to allow the maximum number of client computing devices that are members of a cluster using the same edge node(s). For example, if two or more client computing devices are using the same chat room, they may be grouped together so that they may be assigned to the same node.

In the second phase, once the number of edge nodes has been reduced, the client computing devices may probe the remaining edge nodes. In one or more embodiments, this may take the form of pinging the remaining edge nodes and determining such things as latency and network characteristics. Using the results of the probing, the remaining nodes are ranked and the client computing device may then be assigned to the highest ranked node.

The various aspects may be implemented in many different forms and should not be construed as limited to the implementations set forth herein. The disclosure encompasses variations of the embodiments as described herein. Like numbers refer to like elements throughout.

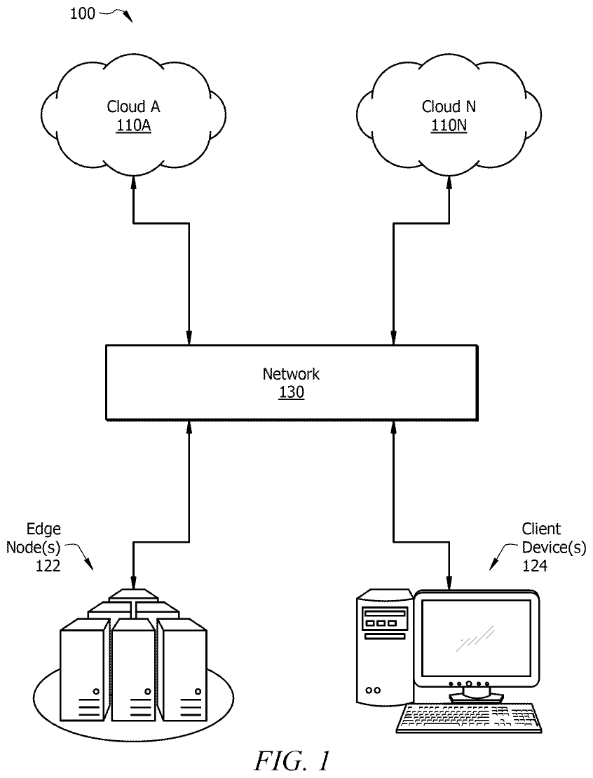

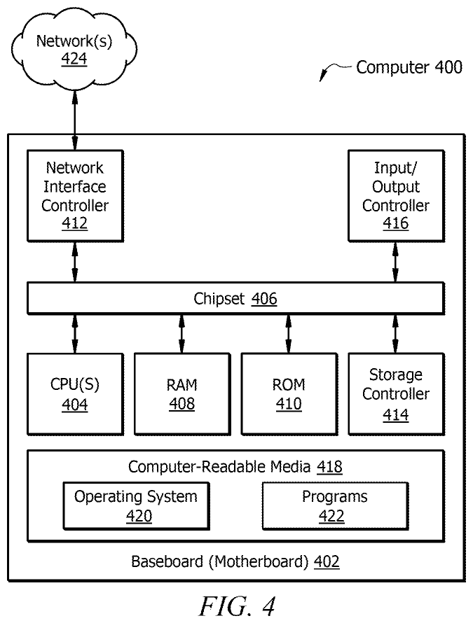

FIG. 1 illustrates a system diagram of an example system for providing resources from one or more cloud servers to client devices according to some aspects of the current disclosure. FIG. 1 further illustrates a distributed cloud environment 100. The distributed cloud environment 100 includes a system architecture that includes two or more cloud servers 110A-110N, edge nodes 122, and client computing devices 124. The distributed cloud environment 100 may include more or less devices than that shown in FIG. 1. The system further includes a network 130 that connects the cloud servers 110A-110N, edge nodes 122, and client computing devices 124. Each of these modules may be virtual and/or one or more may be implemented by a stand-alone server or computational device configured to execute one or more stored instructions, such as that described with regards to FIG. 4.

In some examples, the network 130 may include devices housed or located in one or more of the edge nodes 122 and client computing devices 124, and/or the cloud servers 110A-110N. The network 130 may include one or more networks implemented by any viable communication technology, such as wired and/or wireless modalities and/or technologies. The network 130 may include any combination of personal area networks (PANs), local area networks (LANs), campus area networks (CANs), metropolitan area networks (MANs), extranets, intranets, the Internet, short-range wireless communication networks (e.g., ZigBee, Bluetooth, etc.), wide area networks (WANs)—both centralized and/or distributed—and/or any combination permutation, and/or aggregation thereof. The network 130 may include devices, virtual resources, or other nodes that relay packets from one network segment to another by nodes in the computer network. The network 130 may include multiple devices that utilize the network layer (and/or session layer, transport layer, etc.) in the OSI model for packet forwarding, and/or other layers. The network 130 may include various hardware devices, such as routers, switches, gateways, network interfaces (NICs), application specific integrated circuits (ASICs), field-programmable gate arrays (FPGAs), servers, and/or any other type of devices. Further, the network 130 may include virtual resources, such as virtual machines (VMs), containers, and/or other virtual resources. Additionally, or alternately, the techniques described herein are applicable to container technology, such as Docker®, Kubernetes®, and so forth.

The one or more cloud servers 110A-110N may include one or more data centers comprising a plurality of cloud servers that are located or hosted externally to the organization. The cloud servers 110A-110N may provide data storage, computing power, or other resources through interaction between one or more clouds servers and client computing devices 124. The services hosted by the cloud servers are often provided on an on-demand basis and a variety of tiers of service may be provided that may be reconfigured on demand as needed. This allows the organization to have agility in responding to changing needs and to efficiently use available resources, at least from an economic and energy use perspective.

For example, in a non-limiting example, a cloud server 110A may host a database associated with an under-utilized product. However, due to advertising or other reasons, the product becomes popular. With a cloud environment, the organization may quickly reconfigure or purchase additional computing capacity to handle the additional data and interactions with the database. When the product is no longer being used extensively, the extra capacity may easily be removed or re-dedicated to another product as needed. This flexibility is an advantage of cloud environments.

Further, depending on availability or capabilities, an organization may choose to use a plurality of different cloud servers 110A-110N to host various services/data in environments that meet geographical needs, security needs, and performance needs. Additionally, with cloud environments, a unified security policy may be more easily implemented. Because of centralization, as well as scale, cloud service providers may devote resources to solving issues that many customers cannot afford and/or have the ability to implement locally. However, because the cloud servers 110A-110N may be geographically located far away from the organization and because cloud installations may be complex and expensive, alternatives to the cloud environment are often needed.

One such alternative is an edge computing environment comprising one or more edge nodes 122. Edge nodes 122, much like cloud environments, include one or more datacenters, servers, and/or computing devices. However, unlike cloud environments, the edge nodes are generally located in an organization's datacenter or in small deployments near potential customers. The one or more edge nodes 122 may be physical facilities or buildings located across geographic areas that are designated to store networked services that are part of the network 130. The edge nodes 122 may include various networking devices, as well as redundant or backup components and infrastructure for power supply, data communications connections, environmental controls, and various security devices. The edge nodes may take the form of one or more computing devices as described in more detail below with regards to FIG. 4. Generally, the edge nodes 122 may provide basic resources, such as processor (CPU), memory (RAM), storage (disk), and networking (bandwidth).

Because the edge nodes are located in an organization's own datacenters or nearer to the end users, they may often provide better latency than that of third-party cloud environments, e.g., 110A, which may only have a limited number of servers providing a resource for a large geographical area. For example, there may be only one or two cloud datacenters or environments, e.g., 110A, providing resources to an entire continent, while edge computing devices might be located in each country or even in each major city. This provides better latency since the communications between client computing devices 124 and edge nodes 122 do not need to travel as far. Further, edge nodes 122 often have dedicated high speed connections to the specific cloud servers 110A-110N, which is different than what a client computing device 124 typically communicates with. Even if a resource is ultimately being provided by a server located in the one or more cloud servers 110A-110N, by having the client computing device 124 connect to the edge node 122 rather than directly to a cloud server, e.g., 110A, faster provisioning of the resource may occur.

A client computing device 124 may provide a user, such as an administrator and/or customer, access to one or more resources through the edge node 122 and/or directly from the one more cloud servers 110A-110N. A client computing device 124 may be any computational device such as those described with regards to FIG. 4 below. The client computing device 124 may be connected to the cloud servers 110A-N and/or edge node 122 through the network 130. The client computing device 124 may be located in the same city or locations as the edge node 122 or may be in a separate geographical location. The client computing device 124 may be an end-user's device.

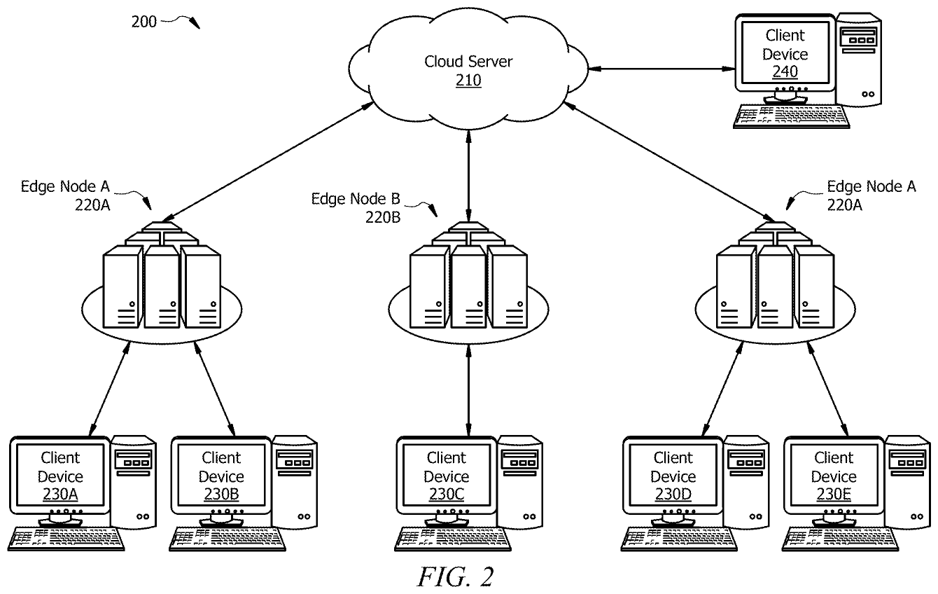

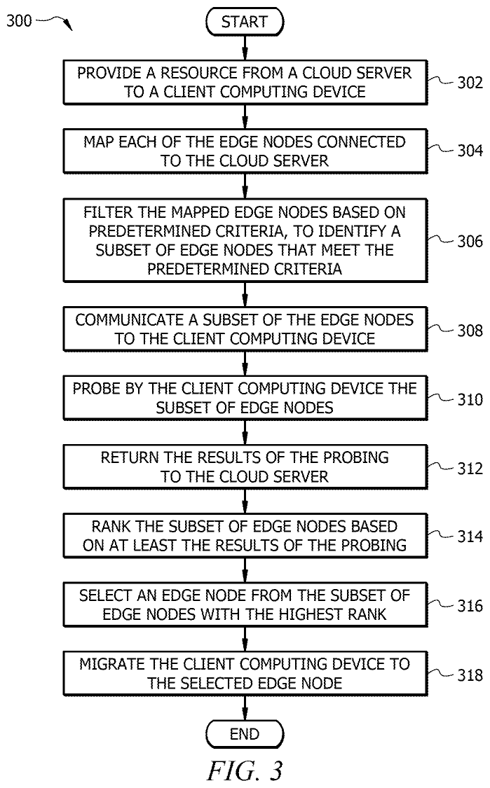

In one or more embodiments the client computing device 124 is initially connected to one or more cloud servers, e.g., 110A. After some time, the client computing device 124 is migrated or associated with an edge node 122, in order to provide improved service and/or reduce costs. The method of determining which edge node of a plurality of edge nodes 122 to select is described next with regards to FIGS. 2 and 3.

FIG. 2 show an exemplary mapping 200 for a given system. The mapping 200 may be produced by one or more cloud servers 210 and/or parts of the application being hosted by the cloud server 210. The mapping may be produced by a media bridge, application control plane, application programing interface (API), and/or any other process or module of the cloud server and/or the provided resource. Alternatively, any of the components described in FIG. 1 may produce the mapping 200 shown in FIG. 2.

The mapping maps a plurality of edge nodes 220A, 220B, and 220C, each of which may include one or more servers or computational devices. The edge nodes 220A, 220B, and 220C are connected to the cloud server 210 along with a plurality of client computing devices 230A, 230B, 230C, 230D, 230E, and 240 that are receiving one or more services either directly from the cloud server 210 or through at least one of the edge nodes 220A, 220B, and 220C. While only three edge nodes 220A, 220B, and 220C and six client computing devices 230A, 230B, 230C, 230D. 230E, and 240 are shown, any number of edge nodes and client computing devices may be used, and the number shown in FIG. 2 is only for explanation purposes. Generally, many more devices would be present in a working system.

The cloud server 210 provides one or more resources to each of the client computing devices 230A, 230B, 230C, 230D, 230E, and 240. These resources may be in the form of an application, such as a real-time video conferencing application, or the resources may be data from such things as a database or other information repository hosted by the cloud server 210. The cloud server may be connected directly to a client computing device 240 or may be connected indirectly through edge nodes 220A, 220B, and 220C, which act as relay nodes, or they may host a copy of the resource themselves.

When a new client computing device 240 initially connects to the cloud server 210, the server begins mapping the one or more edge nodes based on predetermined criteria. Such criteria may be where the edge node is located, how many client computing devices 230A, 230B, 230C, 230D, 230E, and 240 are connected that are using the same resource or communicating with each other, and other criteria. Once the mapping is complete, edge nodes may be filtered.

For example, with a video conferencing application, several client computing devices 230A and 230B may be communicating with each other, for example, in a chat room. If client computing device 240 is, or will be, communicating with client computing devices 230A and 230B, edge node A 220A may be the preferred edge node to assign the client computing device 240. Edge node C 220C, which hosts client computing devices 230D and 230E that are in a separate chat room, may be removed from the mapping.

In another example, if edge node B 220B is physically located outside of a predetermined distance, as set by an administrator, developer, or other concerned party, from the client computing device 240 current location, edge node B 220B may be eliminated. The predetermined distance may be a predetermined range, such as, but not limited to, within ten kilometers, one hundred kilometers, one thousand kilometers, or any other distance as measured between the client computing device 240 and the edge node, e.g., 220A. Returning to the example, if edge node B 220B is located one hundred kilometers away from client computing device 240 and the predetermined range is ten kilometers, then edge node B 220B may be eliminated.

Once the cloud server 210 eliminates one or more edge nodes 220A, 220B, and 220C, the cloud server 210 forwards information identifying the remaining edge nodes (subset of the edge nodes) to the client computing device. For example, if edge node B 220B is eliminated, in the non-limiting example shown in FIG. 2, the cloud server 210 would send the identification information for edge node A 220A and edge node C 220C to client computing device 240. The client computing device 240 would then probe each of the remaining edge nodes (220A and 220C) to determine real-time information, such as, but not limited to, latency and network conditions between the client computing device and the remaining edge nodes (e.g., 220A and 220C in the previous example).

The client computing device then forwards the results of the probing back to the cloud server 210, which then ranks the remaining edge nodes 220A, 220B, 220C, based on their performance information as obtained by the probing. The top ranked edge node, e.g., 220A, is then selected and the client computing device 240 is instructed to migrate to that edge node, e.g., 220A. The ranking may be based solely on the results of the probing, or it may also consider such things as clustering or grouping of client computing devices using the same resource as is determined during the mapping. Other criteria may be used to provide a ranking and the invention is not limited to what has been described.

FIG. 3 illustrates an exemplary method 300 for associating a client computing device with an edge node, in accordance with one or more embodiments.

At step 302, in one or more embodiments, the cloud computing device, e.g., 110A, such as that described above with regards to FIGS. 1 and 2, provides a resource from the cloud computing device to a client computing device. As described above, the resource may be data, an application, asset, or resource hosted by the client computing device. The resource may also include a video conferencing application, a video streaming application, voice over internet phone (VOIP) services, database services, or any other type of resource or service. Additionally, the cloud computing device may host one or more media bridges to provide the resource.

Once the cloud server begins providing the resource in step 302, the cloud server may determine that it is advantageous to migrate or associate the client computing device with an edge node or server. The cloud server then in step 304 maps the various edge nodes that are connected and/or associated with it. The edge nodes are mapped in step 304 and filtered in step 306 based on predetermined criteria, such as, but not limited to, the number of client devices connected to them, their capabilities, the type of clients connected to them, their distance from the client computing device, and other criteria or logical groupings. The predetermined criteria may be application specific, or may be configured by a user, administrator, developer, or other concerned party. In step 306, the edge nodes are filtered to identify a subset of edge nodes that meet the predetermined criteria. Those edge nodes that do not meet the predetermined criteria are eliminated from consideration for being associated with the client computing device. For example, in a non-limiting example, if the predetermined criteria includes the number of client computing devices hosted by an edge node, and a first edge node is determined to host the maximum number of client computing devices already, that node would be eliminated.

This subset of edge nodes is then communicated to the client computing device in step 308. The client computing device then probes each of the edge nodes in the subset of edge nodes in step 310. This may comprise sending pings or other signals to each of the edge nodes to obtain information on network conditions between the client device and each of the subset of edge nodes. Such information may include, but not be limited to, latency, bandwidth, reliability, geographic location relative to the client computing device, and/or any other information that is obtainable through probing.

Once the probing is complete, the probing results are returned to the cloud server in step 312 and the cloud server then ranks each of the edge nodes in the subset of edge nodes based on the results of the probing in step 314. Alternatively, the cloud computing device may perform the ranking without sending the results back to the cloud server and step 312 would be skipped.

In step 314, each of the subset of edge nodes is ranked based on at least the results of the probing. Based on predetermined criteria an edge node may be ranked. For example, in a non-limiting example, an edge node that has high network latency may be ranked lower than an edge node with low network latency. Additionally, information obtained by mapping may also be used in ranking, and an edge node that has more related clients connected to it, but has higher latency, may be ranked higher than an edge node with the lowest latency, but no related clients connected to it. Other combination and criteria may be used for ranking the subset of edge nodes without departing from the invention.

Once the edge nodes are ranked in step 314, the edge node with the highest rank is selected in step 316, and in step 318, the client computing device is signaled or determines that it should begin receiving the resource from the selected edge node. This may entail migrating the client computing device from the cloud server to the selected edge node in step 318, or it may comprise a completely different process for associating the client computing device with the selected node and establishing the selected edge node for providing the resource either as a relay or moving the resource to the selected edge node. Once the client computing device is associated with the selected edge node, the edge node may begin hosting the media bridge for providing the resource to the client device as well as other client devices connected to that edge node.

After step 318, the method may end. In one or more embodiments, the method may be repeated periodically or continually as changes occur in the system, such as, but not limited to, client computing device being added or removed from the system, changes in network conditions, or any other changes that would result in the changing of the initial mapping in step 304 or probing in step 310.

FIG. 4 shows an example computer architecture for a device capable of executing program components for implementing the functionality described above. The computer architecture shown in FIG. 4 illustrates any type of computer 400, such as a conventional server computer, workstation, desktop computer, laptop, tablet, network appliance, e-reader, smartphone, or other computing device, and may be utilized to execute any of the software components presented herein. The computer 400 may, in some examples, correspond to any of the devices, such as the edge nodes 122 and client computing devices 124, as well as components of the cloud servers/environments 110A-110N as shown in FIG. 1, and/or any other device described herein, and may comprise personal devices (e.g., smartphones, tables, wearable devices, and laptop devices), networked devices, such as servers, switches, routers, hubs, bridges, gateways, modems, repeaters, access points, and/or any other type of computing device that may be running any type of software and/or virtualization technology.

The computer 400 includes a baseboard 402, or “motherboard,” which is a printed circuit board to which a multitude of components or devices may be connected by way of a system bus or other electrical communication paths. In one illustrative configuration, one or more central processing units (“CPUs”) 404 operate in conjunction with a chipset 406. The CPUs 404 may be standard programmable processors that perform arithmetic and logical operations necessary for the operation of the computer 400.

The CPUs 404 perform operations by transitioning from one discrete physical state to the next through the manipulation of switching elements that differentiate between and change these states. Switching elements generally include electronic circuits that maintain one of two binary states, such as flip-flops, and electronic circuits that provide an output state based on the logical combination of the state of one or more other switching elements, such as logic gateway. These basic switching elements may be combined to create more complex logic circuits including registers, adders-subtractors, arithmetic logic units, floating-point units, and the like.

The chipset 406 provides an interface between the CPUs 404 and the remainder of the components and devices on the baseboard 402. The chipset 406 may provide an interface to a RAM 408 used as the main memory in the computer 400. The chipset 406 may further provide an interface to a computer-readable storage medium, such as a read-only memory (“ROM”) 410 or non-volatile RAM (“NVRAM”), for storing basic routines that help to startup the computer 400 and to transfer information between the various components and devices. The ROM 410 or NVRAM may also store other software components necessary for the operation of the computer 400 in accordance with the configurations described herein.

The computer 400 may operate in a networked environment using logical connection to remote computing devices and computer systems through a network, such as the network 130 shown in FIG. 1. The chipset 406 may include functionality for providing network connectivity through a network interface (NIC) 412, such as a gigabit Ethernet adapter. The NIC 412 may connect the computer 400 to other computing devices over the network 424. It should be appreciated that multiple NICs 412 may be present in the computer 400, connecting the computer to other types of networks and remote computer systems.

The computer 400 may be connected to computer-readable media 418 or other forms of storage devices that provide non-volatile storage for the computer 400. The computer-readable media 418 may store an operating system 420, programs 422, and other data. The computer-readable media 418 may be connected to the computer 400 through a storage controller 414 connected to the chipset 406. The computer-readable media 418 may consist of one or more physical storage units. The storage controller 414 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 400 may store data on the computer-readable media 418 by transforming the physical state of the physical storage units to reflect the information being stored. The specific transformation of the physical state may depend on various factors, in different embodiments of this description. Examples of such factors may include, but are not limited to, the technology used to implement the physical storage units, whether the storage device is characterized as primary or secondary storage and the like.

For example, the computer 400 may store information to the computer readable media 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete components in a solid-state storage unit. Other transformations of physical media are possible without departing from the scope and spirit of the present description with the foregoing examples provided only to facilitate this description. The computer 400 may further read information from the computer readable media 418 by detecting the physical states or characteristics of one or more locations within the physical storage units.

In addition to the computer-readable media 418 described above, the computer 400 may have access to other computer-readable storage media to store and retrieve information, such as program modules, data structures or other data. It should be appreciated by those skilled in the art that computer-readable storage media is any available media that provides for the non-transitory storage of data, and which may be accessed by the computer 400. In some examples, the operations performed by the client computing device (e.g., FIG. 1, 124), edge node (e.g., FIG. 1, 122), and/or any components included therein, may be supported by one or more devices similar to computer 400. Stated otherwise, some or all the operations performed by the API gateway, and/or any components included therein, may be performed by one or more computers 400.

By way of example and not limitation, computer-readable storage media may include volatile and non-volatile, removable, and non-removable media implemented in a method or technology. Computer-readable storage media includes, but is not limited to, RAM, ROM, erasable programmable ROM (“EPROM”), electrically-erasable programmable ROM (“EEPROM”), flash memory or other solid-state memory technology compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices, or any other medium that may be used to store the desired information in a non-transitory fashion.

As mentioned briefly above, the computer-readable media 418 may store an operating system 420 utilized to control the operation of the computer 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system may comprise the UNIX operating system or one of its variants. It should be appreciated that other operating systems may also be utilized. The computer-readable media 418 may store other system or application programs and data utilized by computer 400.

In one embodiment, the computer-readable media 418 or other computer-readable storage media is encoded with computer-executable instructions which, when loaded into the computer 400, transform the computer from a general-purpose computing system into a special-purpose computer capable of implementing the embodiments described herein. These computer executable instructions transform the computer 400 by specifying how the CPUs 404 transition between states, as described above. According to one embodiment, the computer 400 has access to computer-readable storage media storing computer-executable instructions which, when executed by the computer 400, perform the various processes described above with regards to FIGS. 1-3. The computer 400 may also include computer-readable storage media with instructions stored thereupon for performing any of the other computer implemented operations described herein.

The computer 400 may also include one or more input/output controllers 416 for receiving and processing input from several input devices, such as a keyboard, a mouse, a touchpad, a touch screen, an electronic stylus, or other type of input device. Similarly, an input/output controller 416 may provide output to a display, such as a computer monitor, a flat panel display, a digital projector, a printer, or another type of output device. It will be appreciated that the computer 400 may not include all the components shown in FIG. 1, may include other components that are not explicitly shown in FIG. 1, or may utilize an architecture completely different than that shown in FIG. 1.

The computer 400 may include one or more hardware processors 404 (CPUs) configured to execute one or more stored instructions. The processor(s) 404 may comprise one or more cores. Further, the computer 400 may include one or more network interfaces 412 configured to provide communications between the computer 400 and other devices. The network interface may include devices configured to couple to personal area networks (PANs), wired and wireless local area networks (LANs), wired and wireless wide area networks (WANs), and so forth. For example, the network interfaces may include devices compatible with Ethernet, WI-FI™, and so forth.

While the disclosure is described with respect to the specific examples, it is to be understood that the scope of the disclosure is not limited to these specific examples. Since other modifications and changes varied to fit particular operating requirements, and environments will be apparent to those skilled in the art, the disclosure is not considered limited to the example chosen for purposes of disclosure and covers changes and modifications which do not constitute departures from the true spirit and scope of this disclosure.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

1. A method for associating a client computing device with an edge node, comprising:
providing, by a cloud server, a resource to the client computing device;
mapping, by the cloud server, one or more edge nodes based on predetermined criteria, wherein the one or more edge nodes are separate from the cloud server;
filtering, by the cloud server, the one or more edge nodes to identify a subset of edge nodes that meet the predetermined criteria;
communicating, by the cloud server, the subset of edge nodes to the client computing device;
receiving, by the cloud server, probing results of the subset of edge nodes from the client computing device;
ranking, by the cloud server, the subset of edge nodes based on the probing results;
selecting, by the cloud server, an edge node of the subset of edge nodes with a highest rank to provide the resource to the client computing device;
signaling, by the cloud server, the client computing device to begin receiving the resource from the selected edge node, wherein prior to the signaling the resource is not provided by the one or more edge nodes to the client computing device; and
wherein the probing results are produced by pinging the subset of edge nodes after the communicating and prior to the signaling.

2. The method of claim 1, wherein the predetermined criteria comprises determining a number of other client computing devices using the resource on the one or more edge nodes.

3. The method of claim 2, wherein filtering the one or more edge nodes to identify a subset of edge nodes comprises eliminating the one or more edge nodes that do not host other client computing devices using the resource.

4. The method of claim 2, wherein filtering the one or more edge nodes to identify a subset of edge nodes comprises eliminating the one or more edge nodes that host a maximum number of client computing devices.

5. The method of claim 1, wherein the predetermined criteria comprises network latency between each of the one or more edge nodes and the cloud server.

6. The method of claim 1, wherein the one or more edge nodes comprise one or more media bridges for a real-time application.

7. The method of claim 6, wherein the real-time application is a video conferencing application.

8. The method of claim 1, wherein each of the edge nodes in the subset of edge nodes are ranked based on an amount of latency detected by the probing results between the client computing device and each of the subset of edge nodes.

9. A system, comprising:
a client computing device;
one or more edge nodes; and
a cloud server, the cloud server comprising:
one or more processors; and
one or more computer-readable non-transitory storage media coupled to the one or more processors that stores instructions operable when executed by the one or more processors to cause the system to perform a method comprising:
providing, by the cloud server, a resource to the client computing device;
mapping, by the cloud server, the one or more edge nodes based on predetermined criteria, wherein the one or more edge nodes are separate from the cloud server;
filtering, by the cloud server, the one or more edge nodes to identify a subset of edge nodes that meet the predetermined criteria;
communicating, by the cloud server, the subset of edge nodes to the client computing device;
receiving, by the cloud server, probing results of the subset of edge nodes from the client computing device;
ranking, by the cloud server, the subset of edge nodes based on the probing results;
selecting, by the cloud server, an edge node of the subset of edge nodes with a highest rank to provide the resource to the client computing device;
signaling, by the cloud server, the client computing device to begin receiving the resource from the selected edge node, wherein prior to the signaling the resource is not provided by the one or more edge nodes to the client computing device; and
wherein the probing results are produced by pinging the subset of edge nodes after the communicating and prior to the signaling.

10. The system of claim 9, wherein the predetermined criteria comprises determining a number of other client computing devices using the resource on the one or more edge nodes.

11. The system of claim 10, wherein filtering the one or more edge nodes to identify a subset of edge nodes comprises eliminating the one or more edge nodes that do not host other client computing devices using the resource.

12. The system of claim 10, wherein filtering the one or more edge nodes to identify a subset of edge nodes comprises eliminating the one or more edge nodes that host a maximum number of client computing devices.

13. The system of claim 9, wherein the predetermined criteria comprises network latency between each of the one or more edge nodes and the cloud server.

14. The system of claim 9, wherein the one or more edge nodes comprise one or more media bridges for a real-time application.

15. The system of claim 14, wherein the real-time application is a video conferencing application.

16. The system of claim 9, wherein each of the edge nodes in the subset of edge nodes are ranked based on an amount of latency detected by the probing results between the client computing device and each of the subset of edge nodes.

17. At least one non-transitory computer-readable storage medium having stored therein instructions which, when executed by one or more processors, cause the one or more processors to:
provide, by a cloud server, a resource to a client computing device;
map, by the cloud server, one or more edge nodes based on predetermined criteria, wherein the one or more edge nodes are separate from the cloud server;
filter, by the cloud server, the one or more edge nodes to identify a subset of edge nodes that meet the predetermined criteria;
communicate, by the cloud server, the subset of edge nodes to the client computing device;
receive, by the cloud server, probing results of the subset of edge nodes from the client computing device;
rank, by the cloud server, the subset of edge nodes based on the probing results;
select, by the cloud server, an edge node of the subset of edge nodes with a highest rank to provide the resource to the client computing device;
signal, by the cloud server, the client computing device to begin receiving the resource from the selected edge node, wherein prior to the signaling the resource is not provided by the one or more edge nodes to the client computing device; and
wherein the probing results are produced by pinging the subset of edge nodes after the communicating.

18. The non-transitory computer-readable storage medium of claim 17, wherein the predetermined criteria comprises determining a number of other client computing devices using the resource on the one or more edge nodes.

19. The non-transitory computer-readable storage medium of claim 17, wherein the one or more edge nodes comprise one or more media bridges for a real-time application.

20. The non-transitory computer-readable storage medium of claim 17, wherein each of the edge nodes in the subset of edge nodes are ranked based on an amount of latency detected by the probing results between the client computing device and each of the subset of edge nodes.
